(19) United States
(12) Patent Application Publication
(10) Pub. No.: US 2007/0075504 A1
(43) Pub. Date: Apr. 5, 2007

(54) Device for delimiting two spaces relative to each other in a liquid-tight or gas-tight fashion

(76) Inventor: Ralf Kurz, Gengen (DE)

Correspondence Address: Homer W. Faucett, III;ICE MILLER, One American Square, Box 82001, Indianapolis, IN, 46282-0200, US

(21) Appl. No.: 11/242,542

(22) Filed: Oct. 3, 2005

(51) Int. Cl. F16L 5/02

(52) U.S. Cl. 277/606

(57) ABSTRACT

The invention relates to a device for airtight or fluid-tight separation of two spaces from another having a body comprising a first surface, which forms the interface with a first of the two spaces, and a second surface, which forms the interface to the second space; the body is formed from a gel or is loosely applied to the gel. According to this invention such a device has the following features: at least a portion of at least one of the two interfaces is formed by a membrane; the membrane is fixedly connected to the gel compound or is formed from the gel compound itself.

The invention relates to a sealing device with which two rooms or spaces can be separated or delineated with respect to one another.

Such devices are used in so-called house lead-in or service entrance combinations, which are used when a line is passed through a wall. The wall may be, for example, the outside wall of a house. The one of the two spaces is then an inside room or space of the house and the other space is the outside environment. The wall has a borehole which is oversized with respect to the cross section of the line, leaving an annular space between the line and the inside curvature of the borehole. This annular space must be filled because otherwise it would constitute a conducting connection between the two spaces, which is undesirable. The annular space is filled with an elastic body, e.g., a rubber ring body. The rubber ring body surrounds the line and is itself in contact with the inside curvature of the bore along the outer lateral surface of the line. The rubber ring body is pressed against the inside curvature of the bore by axial compression.

To fill up the annular space, however, a gel compound may also be used. To do so, the gel compound is introduced into the borehole. The gel compound then forms a gel plug which sits tightly on the inside curvature of the borehole. Then the line is passed through the gel compound. The gel compound then surrounds the line. This secures the line in the borehole on the one hand while on the other hand also establishing a separation or delineation between the two spaces.

The introduction of a gel compound thus has the advantage that it is extremely simple. However, it also has the following disadvantage: if the line is pushed through the gel compound, the gel compound remains adhering to the outer lateral surface of the line, and a portion of the gel compound is entrained by the line in its axial puncturing movement. This is not desirable because this withdraws gel compound from the gel plug, so there is no longer enough gel compound in the borehole and therefore a reliable, tight and secure clamping of the line in the borehole is no longer ensured. The entraining effect may even go to such an extent that the entire gel plug is pulled out of the borehole in the movement of the line through the borehole.

One might consider applying sheet metal with a borehole for passing the line through on the outside of the gel plug, i.e., at the point where the line comes out. However, the borehole in the metal plate would have to be oversized to a certain extent in comparison with the line. This would then again result in an annular gap through which gel could escape, so the problem would still remain just as before.

The object of the present invention is to create a device according to the preamble of Claim 1 such that the advantages of the gel material are retained but the disadvantages are avoided. This should prevent gel compound from being entrained in passing a line through the borehole in the direction of movement of the line.

This object is achieved through the characterizing features of Claim 1. According to Claim 1, the gel compound is provided with a membrane on at least one of its interfaces, in particular on the interface through which the line emerges from the gel compound when pushed through the borehole. The membrane prevents entrainment of gel compound beyond this interface.

This of course means that the membrane must have a certain elasticity or strength or toughness or ultimate tensile strength. The material of the membrane—like the gel compound itself— must tend to retain its original shape when a line is passed through it so that the membrane continues to tightly surround the line and thereby prevent gel particles from being entrained from the lateral surface of the line.

Numerous materials may be considered as the membrane material. For example, a rubber membrane might be provided. A film might also be used such as that used in garden ponds. However, a gel-inherent membrane, i.e., a membrane which in turn consists of a gel, perhaps the same gel as the main mass of the gel body.

In any case, the membrane must be intimately bonded to the (remaining) gel body so that it remains on the main gel body and is not entrained, e.g., by friction on the lateral surface of the line.

The gel-inherent membrane may be formed by physical or chemical action, so that it is not identified as a foreign body.

The membrane need not necessarily extend over the entire interface of the body. The main thing is that it is located where a line passes through the body. In the extreme case, the membrane may surround the line only in a ring area, i.e., it may even have the shape of a ring itself, which is naturally inseparably attached to the remaining gel body or is in one piece with the latter.

The present invention is explained in greater detail with reference to the drawing in which the following figures are shown in detail:

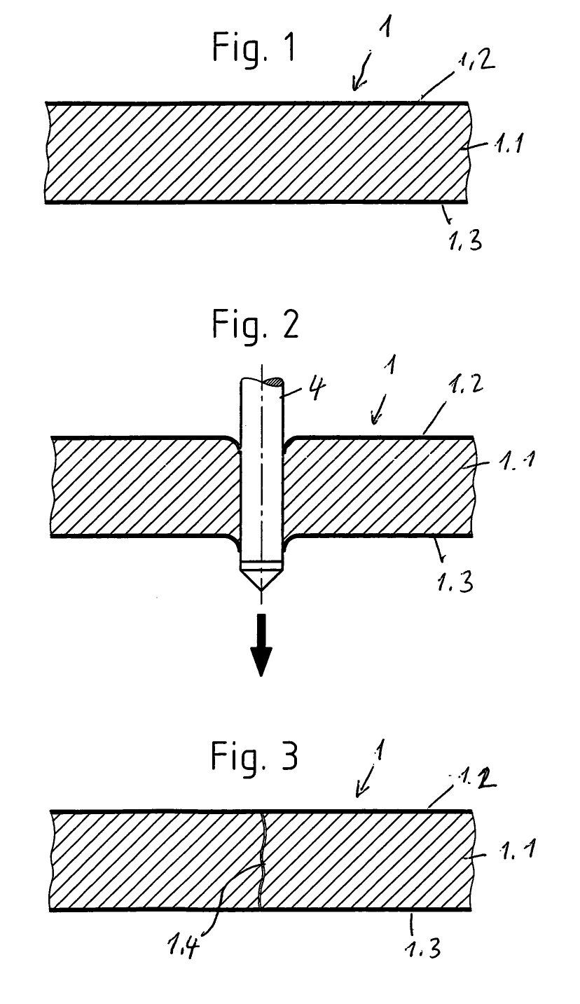

FIG. 1 shows a body through which an elongated body, e.g., a rod, is to be passed before puncturing the body with the rod.

FIG. 2 shows the object of FIG. 1 with the rod in the stage of puncture.

FIG. 3 shows the object of FIG. 1 after puncture and insertion of the rod according to FIG. 2.

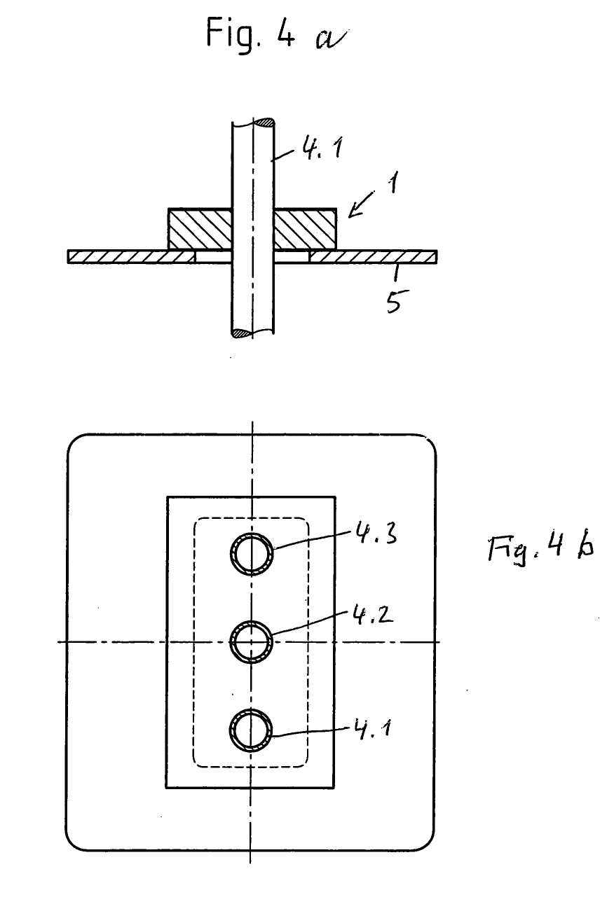

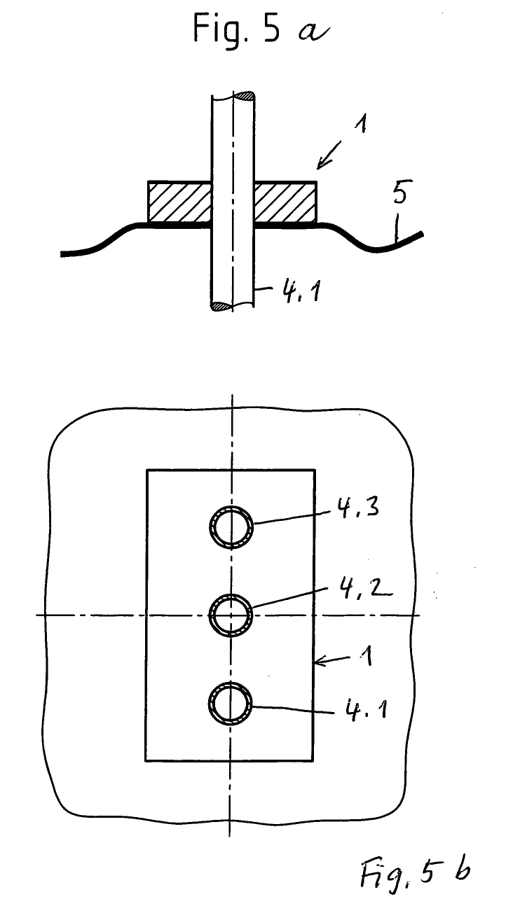

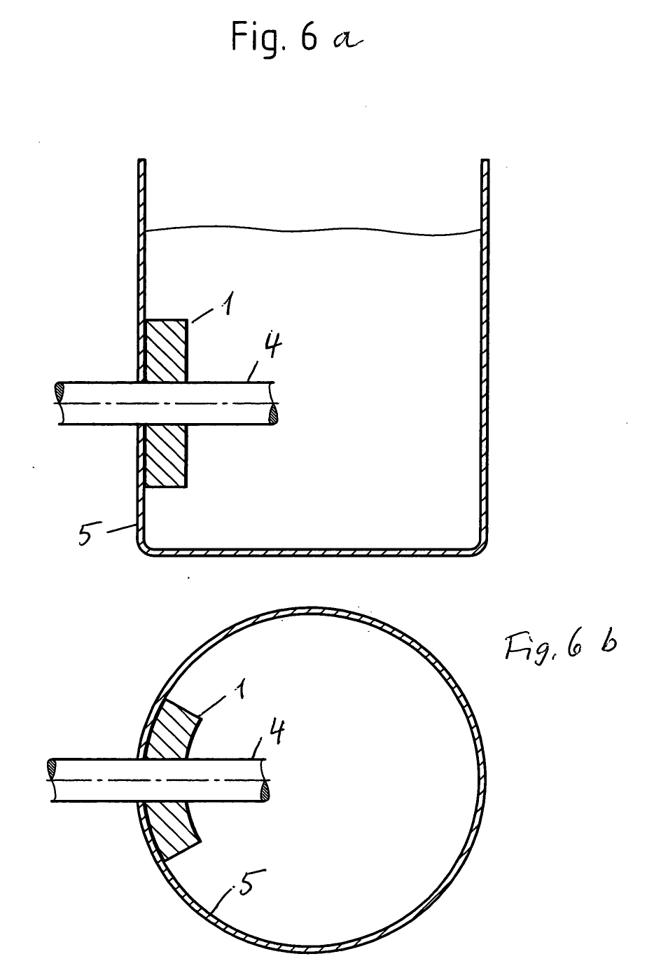

FIG. 4a illustrates another application case in which a line is passed through a gel body and through a container wall.

FIG. 4b shows the object from FIG. 1 in a top view with a cross section through the lines.

FIG. 5a shows another application form like that in FIG. 4a.

FIG. 5b shows the object of FIG. 5a in a view from above, again with the lines shown in cross section.

FIG. 6a shows a container with a line passing through one wall.

FIG. 6b shows a horizontal section through the object FIG. 6a.

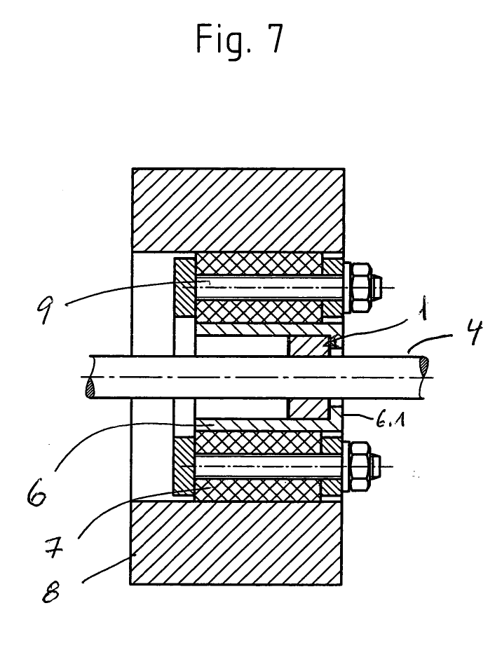

FIG. 7 shows a so-called house lead-in or service entrance combination in a vertical section.

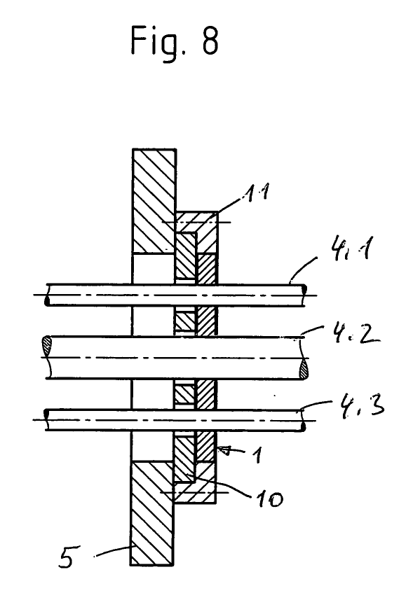

FIG. 8 shows a wall with three lines passing through it.

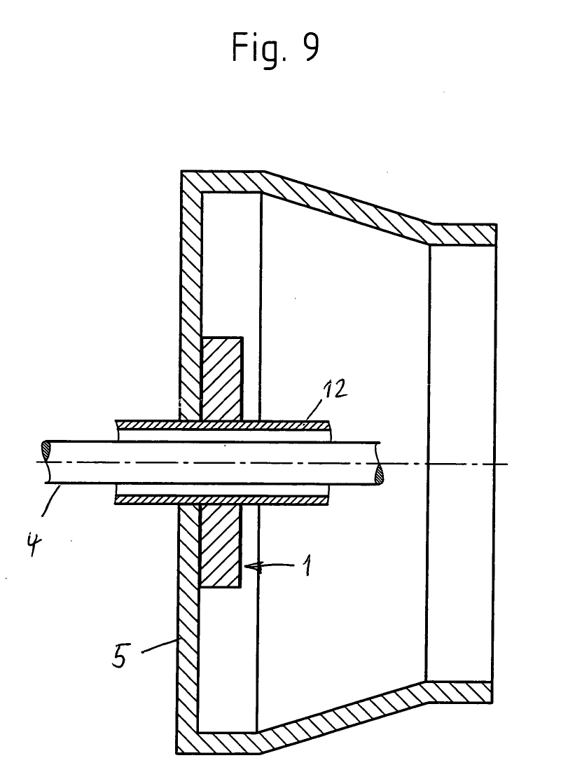

FIG. 9 shows an application with a wall through which a supporting sleeve passes, in turn surrounding a line.

FIG. 1 shows a gel body 1 which includes a gel core 1.1 and a gel-inherent membrane 1.2 on one side of the gel core 1.1 and a gel-inherent membrane 1.3 on the other side.

The term “gel” is understood to refer to a chemically or physically linked polymer network, which is swollen in a medium in any aggregate state. It consists of at least two components that are distributed more or less continuously in a given volume.

Different swelling properties of gels are found, based on the type of linkage points in a network:
In the case of physically linked networks, in general there is a gel-sol transition. Depending on the temperature and/or amount of swelling agent, the polymer forms a gel, but it may also be brought to the sol state without destroying the individual polymer chains. The polymer-swelling agent system then forms a solution. The process is reversible, which is why these gels are also known as “thermoreversible gels.”
In the case of chemically linked networks, however, a gel-sol transition is achieved only with irreversible degradation of the network structure. The network is capable of absorbing swelling agent only up to a certain extent, the so-called saturation, or equilibrium degree of swelling.

In the gel state of a chemically linked network, the external form of the network and the rubber elasticity are retained. From a physical standpoint, a gel has both elastic and viscous properties. It is therefore viscoelastic. The gel state is also formed in the case of networks that have solidified in a vitreous form with a suitable swelling agent at a temperature below their glass transition point.

FIG. 2 again shows the gel body according to FIG. 1 with a rod 4 inserted. Instead of the rod, a line could also be inserted through it. The arrow indicates the direction of insertion.

As can be seen, both the gel membrane 1.2 and the gel membrane 1.3 are entrained by the rod 4 to a certain extent (see the meniscus on both gel membranes). However, there is only very minor entrainment in comparison with a gel body without such a membrane. The reason is that the gel membrane 1.2 and/or 1.4 surrounds the rod 4 so tightly that gel cannot be entrained out of the gel core by the lateral surface of the rod 4 to any mentionable extent. The material of the gel membrane 1.2 and/or 1.3 may apply a greater elastic force than the material of the gel core 1.1.

FIG. 3 illustrates the state in which the rod 4 has been completely passed through and out of the gel body 1. This also shows a void 1.4, but it has an extremely small diameter. However, the void 1.4 disappears completely or almost completely after a short period of time, in particular when pressure is applied to the gel body 1 in the radial direction.

In the embodiment according to FIGS. 4a and 4b, three pipelines 4.1, 4.2, and 4.3 are passed through a gel body 1. The gel body is in the form of a cube. It sits on a wall 5. The wall 5 may consist of a thin sheet metal. The gel body 1 in turn surrounds a gel core 1.1 and a gel-inherent membrane 1.2 which forms one side face of the gel body 1 and a gel-inherent membrane 1.3, which form the other side. It may be sufficient to provide only a single side of the gel core 1.1 with a gel-inherent membrane, namely the bottom side, where the lines 4.1, 4.2, 4.3 emerge after passing through the gel body 1.

The wall 5 has a borehole 5.1.

FIGS. 5a and 5b show an embodiment, which is similar to that according to FIGS. 4a and 4b. The wall 5 here consists of a film or a membrane made of rubber or plastic, for example.

FIG. 6 in turn shows a line 4 passing through a gel body 1 and through a container wall 5.

In the embodiment according to FIG. 7, the following details can be discerned. A line 4 has been passed through the gel body 1 by puncturing the latter, namely in the direction from left to right. The gel body 1 sits in a receiving sleeve 6. The receiving sleeve 6 is surrounded by a rubber 7. The rubber ring 7 is surrounded by a bushing 8. The rubber ring 8 [sic; 7] can be compressed by tightening several screws 9 in the axial direction, causing it to expand radially so that the receiving sleeve 6 is clamped tightly. Instead of the bushing 8, a wall of a building is also conceivable, provided with a borehole for introducing the rubber ring.

FIG. 8 shows another embodiment where again three lines 4.1, 4.2, and 4.3 of different diameters have been passed through a borehole in a wall 5. A gel body 1 is provided, again designed as a gel core 1.1, sandwiched between a gel-inherent membrane 1.2 and a gel-inherent membrane 1.3. Between the gel body 1 and the wall 5 there is a perforated supporting plate 10. A holding ring 11 is attached to the wall 5, surrounding the supporting plate 10 by being in contact with one side face on the peripheral area of same at its circumferential surface. At the same time it also surrounds the gel body 1.

The embodiment according to FIG. 9 is especially interesting. Here again, there is a line 4, a gel body 1 with a gel core 1.1, and a gel-inherent membrane 1.2 and 1.3 as well as a container with a container wall 5. The special thing about this embodiment is a sheathing pipe 12. The procedure for installing the entire unit is as follows: the gel body 1 is placed on one side of the wall 5 and attached to it, e.g., by adhesive bonding. Then the sheathing pipe 12 is inserted through the gel body 1 from right to left by pushing or puncturing. Then the line 4 is passed through the sheathing body 12. Next the sheathing pipe 12 can be pulled out of the gel body 1 and out of the wall 5. Because of the elasticity of the gel material, the gel body shrinks so that it reliably surrounds the line 4, forming a seal. The sheathing pipe 12 can be used in several installation processes in succession in this way.

In the embodiments according to FIGS. 4.a, 4.b, 5.a and 5.b, 6 and 9, the gel body 1 is adhesively bonded to the wall. In the embodiment according to FIG. 7, one side of the gel body 1, formed by a membrane according to this invention, is adhesively bonded to a collar 6.1 of the receiving sleeve 6 and is adhesively bonded to this collar.

In the embodiment according to FIG. 8, the gel body 1 is adhesively bonded to the supporting plate 10.

The bondability of inventive gel bodies is another major advantage of the inventive embodiment. Without a membrane, bonding is difficult or impossible. The gel body can be bonded easily and reliably to another surface, e.g., a container wall with any side surface formed out of the membrane.

Gel forms that are especially favorable include polyurethane gels having dimensional stability. They are characterized by a particularly high expansion. Their tensile strength can be selected in the following ranges:
soft: 140 to 200 kPa
medium: 200 to 300 kPa
hard: 300 to 400 kPa.

Films of polyurethane have proven advantageous in cases when the membrane is a separate membrane applied to a gel core. The membrane may also be applied loosely to the gel core.

It is particularly advantageous to use an inventive device in a so-called house lead-in or service entrance combination as described in the introduction.

### List of Reference Numerals

1 gel body

1.1 gel core

1.2 gel-inherent membrane

1.3 gel-inherent membrane

1.4 void

4 line or rod-shaped body

4.1 line

4.2 line

4.3 line

5 container wall

5.1 borehole

6 receiving sleeve

7 rubber ring

8 bushing

9 screw

10 supporting plate

11 holding ring

12 sheathing pipe

1. Device for fluid-tight or airtight separation of two rooms or spaces from one another;
1.1 having a body comprising a first face, which forms the interface to a first of the two spaces, and a second face, which forms the interface to the second space;
1.2 the body (1) is formed from a gel characterized by the following features:
1.3 at least a portion of at least one of the two interfaces is formed by a membrane (1.2, 1.3);
1.4 the membrane (1.2, 1.3) is permanently attached to the gel compound or is formed by the gel compound itself or is loosely applied to the latter.

2. Device according to claim 1, characterized in that the membrane (1.2, 1.3) has an elasticity that is between half and twice the elasticity of the gel compound.

3. Device according to claim 2, characterized in that the elasticity of the membrane (1.2, 1.3) is between 1 and 2 times the elasticity of the gel compound.

4. Device according to one of claims 1 through 3, characterized in that the membrane is a gel-inherent membrane, which is formed by physical or chemical treatment of the surface of the gel core.

5. Device according to one of claims 1 through 3, characterized in that the membrane (1.2, 1.3) is applied to a gel core (1.1).

6. Device according to claim 5, characterized in that the membrane consists of a film.

7. Device according to claim 5 or 6, characterized in that the membrane consists of polyuritan [sic; polyurethane] or some other plastic.

8. House lead-in combination for passing at least one line through a passage in a wall separating two spaces in an airtight or watertight manner from one another in a building.
8.1 with a device for forming a barrier for the interspace between the inside curvature of the passage through the wall and in sheathing of the pipelines;
characterized by the following features:
8.2 the device for forming the barrier is a device according to one of features 1 through 7.
